(19) United States
(12) Patent Application Publication
(10) Pub. No.: US 2009/0217634 A1
(43) Pub. Date: Sep. 3, 2009

(54) Apparatus For Trapping Residual Product Of Semiconductor Manufacturing Process

(75) Inventor: Young Kwan Choi, Gyeonggi-do (KR)

Correspondence Address: IPHORGAN, LTD., 1130 LAKE COOK ROAD, SUITE 240, BUFFALO GROVE, IL, 60089, US

(73) Assignee: NEWPROTECH CO., LTD., Gyeonggi-do (KR)

(21) Appl. No.: 11/988,107

(22) PCT Filed: Jul. 1, 2006
(86) PCT No.: PCT/KR2006/002537

§ 371 Date: Jan. 16, 2008

(30) Foreign Application Priority Data
Jul. 1, 2005 (KR) 10-2005-0059352

(51) Int. Cl. B01D 8/00

(52) U.S. Cl. 55/426; 55/434.2; 55/428.1

(57) ABSTRACT

An apparatus for trapping residual product of semiconductor manufacturing processes increases trapping effect and trapping capacity of residual product of reaction by maximizing an effective area for the residual product of reaction to be trapped while actively preventing the residual product of reaction generated in a process chamber during a thin film deposition and etching process from sucking into a vacuum pump, thereby easily removing the trapped residual product of reaction, including hollow housing having an inner containing space, first connection pipe connecting process chamber and housing, second connection pipe connecting vacuum pump and housing, and a protrusion extending inwardly and protruding from a housing base, cooling element disposed inside the housing for cooling the residual product of reaction flowing into the housing through the first connection pipe, and trap plates disposed inside the housing as multiple layers on which the residual product of reaction is laminated.

### CROSS-REFERENCE TO RELATED APPLICATIONS

This application relies for priority on PCT/KR2006/002537 (WO 2007/004808), filed on Jun. 29, 2006 and on Korean Patent Application No. 10-2005-0059352, filed on Jul. 1, 2005, both applications being completely incorporated by reference herein.

### BACKGROUND OF THE INVENTION

1. Technical Field

The present invention relates to a semiconductor device, and more particularly, to an apparatus for trapping a residual product of semiconductor manufacturing process, which increases a trapping effect and a trapping capacity of a residual product of reaction by maximizing an effective area for the residual product of reaction to be trapped in practice while actively preventing the residual product of reaction generated in a process chamber during a thin film deposition and etching process from sucking into a vacuum pump, thereby easily removing the trapped residual product of reaction.

2. Background Art

In general, a semiconductor manufacturing process is briefly classified into a pre-process (a fabrication process) and a post-process (an assembly process). The pre-process is defined as a semiconductor chip manufacturing process in which a thin film is deposited on a wafer in a chamber where a variety of processes are carried out, and a specific pattern is processed by repeatedly etching the deposited thin film in a selective manner. The post-process is defined as a process in which chips manufactured in the pre-process are individually separated, and then are combined with a lead frame to be assembled as a finished product.

In this case, the process of depositing the thin film on the wafer or the process of etching the thin film deposited on the wafer is performed at high temperature by using a noxious gas (e.g., silane, arsine, and boron chloride) and a process gas (e.g., hydrogen) in the process chamber. During the process is performed, a variety of combustion gases and a noxious gas, which contains a corrosive foreign substance and a noxious substance, are generated in great quantities.

Therefore, in a semiconductor manufacturing device, a scrubber is installed at the rear end of a vacuum pump that makes a process chamber vacuous. The scrubber clarifies an exhaust gas discharged from the process chamber, and emits the clarified gas to the air.

The exhaust gas discharged from the process chamber is solidified and changed into powder when in contact with the air or when an ambient temperature is low. The powder is fixed to an exhaust line, thereby increasing an exhaust pressure. Further, if the powder flows into the vacuum pump, it causes a mechanical trouble in the vacuum pump and a backflow of the exhaust gas. Therefore, there has been a problem in that the wafer is contaminated in the process chamber.

In order to solve the above problems, as shown in FIG. 1, a residual product trapping apparatus is installed between a process chamber 10 and a vacuum pump 30 to adhere an exhaust gas discharged from the process chamber 10 in a powder state.

The process chamber 10 and the vacuum pump 30 are connected to a pumping line 60, and a trap pipe 70 is installed to branch off so as to trap and accumulate a residual product of reaction generated in the process chamber 10 in a powder state.

In the case of the conventional residual product trapping apparatus, a non-reactive gas generated inside the process chamber 10 during a thin film deposition or etching process is solidified into a powder 90 while flowing into the pumping line 60 at a temperature relatively lower than that of the process chamber 10. Thereafter, the non-reactive gas braches off from the pumping line 60 to be accumulated in the trap pipe 70.

In this case, the reason why the trap pipe 70 is installed by branching off from the pumping line 60 is to prevent the powder 90 from flowing into the vacuum pump 30.

However, the conventional powder trapping apparatus has the following disadvantages.

First, since it takes long time for the residual product of reaction generated inside the process chamber 10 to be converted into a powder state and accumulated in the trap pipe 70, a total processing time is disadvantageously increased to that extent. When the residual product of reaction, which is generated during a thin film deposition or etching process, is rapidly converted into powder and is accumulated in the trap pipe 70, and thus the residual product of reaction does not exist inside the process chamber 10, a next thin film deposition or etching process can be carried out. However, since it takes long time for the residual product of reaction to be converted into powder, the process chamber 10 has to wait for a longer time until the residual product of reaction is entirely removed from the process chamber 10, in order to perform a next process. Accordingly, an equipment operation rate diminishes, and a total assembly time TAT increases to that extent due to a long waiting time of the process chamber 10.

Second, although the trap pipe 70 branches off from the pumping line 60, there has still been a problem in that a large amount of residual product of reaction or powder flows into the vacuum pump 30.

Third, since the trap pipe 70 has a very narrow space, the powder accumulated in the trap pipe 70 has to be frequently removed, causing inconvenience.

Fourth, the removal of the powder accumulated in the trap pipe 70 is a difficult task because the residual product trapping apparatus has to be disassembled one by one.

### SUMMARY OF THE INVENTION

### Technical Goal of the Invention

In order to solve the aforementioned problems, an object of the present invention is to provide a residual product trapping apparatus which can further effectively trap a residual product of reaction generated during a thin film deposition or etching process in a process chamber.

Another object of the present invention is to provide a residual product trapping apparatus which can easily remove a trapped residual product of reaction.

### Disclosure of the Invention

According to an aspect of the present invention, there is provided a residual product trapping apparatus which is disposed between a process chamber and a vacuum pump and traps a residual product of reaction generated during a thin film deposition or etching process, the apparatus comprising: a hollow housing having an inner containing space; a first connection pipe which is formed at the upper side of the housing to connect the process chamber and the housing, and allows the residual product of reaction discharged from the process chamber to flow into the housing; a second connection pipe which connects the vacuum pump and the housing, and includes a protrusion which inwardly extends and protrudes from a base of the housing; trap plates which are disposed inside the housing in the form of multiple layers and on which the residual product of reaction is laminated; and a cooling element which is disposed inside the housing and cools the residual product of reaction flowing into the housing through the first connection pipe.

In the aforementioned aspect of the present invention, the apparatus may further comprise a shielding cap which is disposed inside the housing and is separated from the protrusion to surround the vicinity of the entrance of the protrusion of the second connection pipe, so as to block the falling residual product of reaction flowing out through the second connection pipe. In addition, the shielding cap may have a shape of a container of which a lower side facing the second connection pipe is open, and an upper surface is fixed to a trap plate which is included in the trap plates and is disposed at the lowermost layer.

In addition, the containing space of the housing may have a wider space in the horizontal direction than the vertical direction, so that the trap plates having a wider area can be installed in the containing space of the same volume. In addition, the housing may have a cylindrical shape of which left and right sides are open, and includes a main body respectively connected to the first connection pipe and the second connection pipe, and a pair or covers which are respectively connected to the left and right sides of the main body and blocks the opening sides of the main body.

In addition, at least one of the covers may be rotatably hinge-connected to the main body in an opening and closing manner against the main body.

In addition, one ends of the trap plates may be bonded to and supported by any one of the covers, and the cover to which each of the trap plates may be bonded can be connected to or separated from the main body.

In addition, the apparatus may further comprise a guide rail which is disposed inside the inner circumferential surface of the main body such that each of the trap plates can be rotatably supported in a sliding manner.

In addition, the cooling element may include a coil type cooling line having a shape of coil that is repeatedly bent and adjacent to the trap plates and reduces an internal temperature of each of the trap plates and the housing while circulating a refrigerant.

In addition, the trap plates may include a plurality of punching holes. In addition, each of the trap plates may include a trap plate having a relatively large punching hole and a trap plate having a relatively small punching hole are alternately disposed in each layer.

According to another aspect of the present invention, there is provided a residual product trapping apparatus which is disposed between a process chamber and a vacuum pump and traps a residual product of reaction generated during a thin film deposition or etching process, the apparatus comprising: a hollow housing having an inner containing space; a first connection pipe which connects the process chamber and the housing; a second connection pipe which connects the vacuum pump and the housing, and includes a protrusion which inwardly extends and protrudes from a base of the housing; a cooling element which is disposed inside the housing and cools the residual product of reaction flowing into the housing through the first connection pipe; and a shielding cap which is disposed inside the housing and is separated from the protrusion to surround the vicinity of the entrance of the protrusion of the second connection pipe, so as to block the falling residual product of reaction flowing out through the second connection pipe.

According to another aspect of the present invention, there is provided a residual product trapping apparatus which is disposed between a process chamber and a vacuum pump and traps a residual product of reaction generated during a thin film deposition or etching process, the apparatus comprising: a housing which includes a main body, of which left and right sides are open and which has a wider containing space in the horizontal direction than the vertical direction, and a pair of circular plate shaped covers which are respectively joined to the left and right sides of the main body and blocks the opening sides of the main body, wherein any one of the covers is hinge-joined with the main body so as to rotate against the main body in an opening and closing manner; a first connection pipe which connects the process chamber and the housing; a second connection pipe which connects a vacuum pump disposed to make the process chamber vacuous and the housing and in which a protrusion inwardly extends and protrudes from the inner side of the housing to block the residual protrude of reaction flowing out along the inner surface of the housing; a plurality of trap plates which are disposed inside the housing in the form of multiple layers wherein two types of trap plates having relatively large and small punching holes are alternately disposed in each layer, and in which the residual product of reaction is laminated; a shielding cap which is disposed inside the housing and is separated from the protrusion to surround the vicinity of the entrance of the protrusion of the second connection pipe, has a shape of a container of which a lower side facing the second connection pipe is open and of which an upper surface is fixed to a trap plate included in the trap plates and disposed at the lowermost layer, and blocks the falling residual product of reaction flowing out through the second connection pipe; and a cooling element which includes a coil type cooling line having a shape of coil that is repeatedly bent and adjacent to each of the trap plates and reduces an internal temperature of each of the trap plates and the housing while circulating a refrigerant, and cools the residual product of reaction flowing into the housing through the first connection pipe.

### BRIEF DESCRIPTION OF THE DRAWING FIGURES

FIG. 1 shows a conventional powder trapping apparatus of semiconductor equipment;

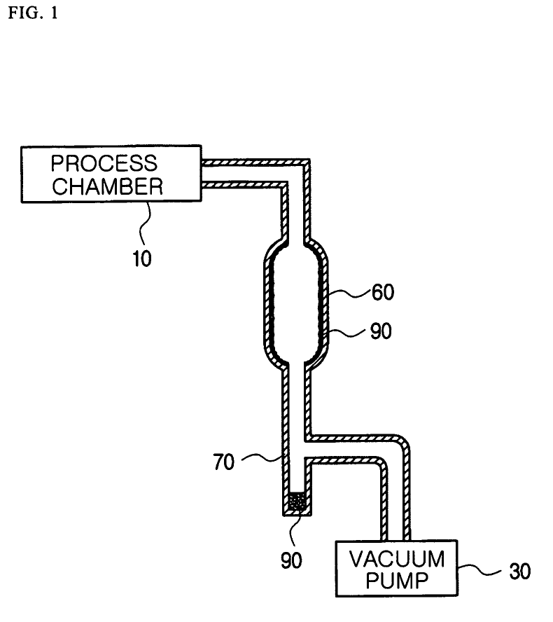

FIG. 2 shows a connection relation between a residual product trapping apparatus and a process chamber according to an embodiment of the present invention;

FIG. 3 is a perspective view of a residual product trapping apparatus according to an embodiment of the present invention;

FIG. 4 is a partial exploded perspective view of the residual product trapping apparatus of FIG. 3;

FIG. 5 is a front projection view of the residual product trapping apparatus of FIG. 3;

FIG. 6 is an exploded perspective view of a main body and a cover of the residual product trapping apparatus of FIG. 3;

FIG. 7 is a perspective view of a residual product trapping apparatus according to another embodiment of the present invention;

FIG. 8 is a lateral projection view of the residual product trapping apparatus of FIG. 7; and

FIG. 9 is an exploded perspective view of a main body and a cover of the residual product trapping apparatus of FIG. 7.

### DETAILED DESCRIPTION OF THE PREFERRED EMBODIMENTS

Hereinafter, an exemplary embodiment of the present invention will be described in detail with reference to the accompanying drawings.

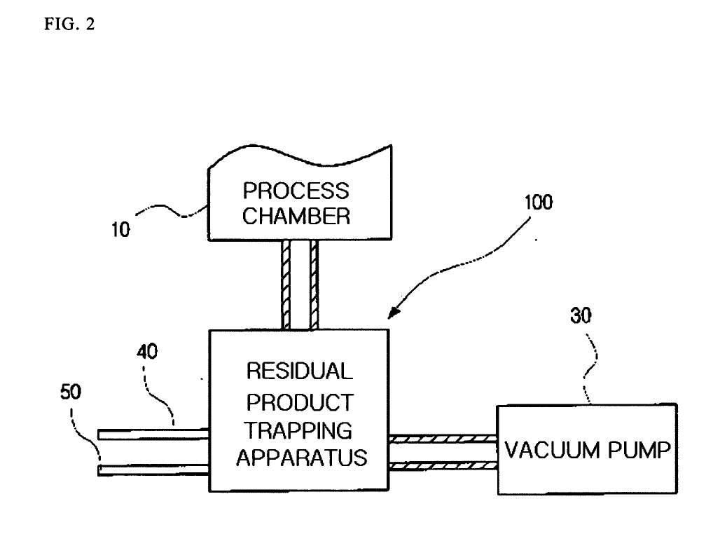

FIG. 2 shows a connection relation between a residual product trapping apparatus and a process chamber according to an embodiment of the present invention.

Referring to FIG. 2, the residual product trapping apparatus 100 is connected to a process chamber 10 in which a residual product of reaction is generated in a thin film deposition or etching process during a semiconductor/LCD manufacturing process or its equivalent process. The other side of the residual product trapping apparatus 100 is connected to a vacuum pump 30 which makes the inner side of the process chamber 10 vacuous by means of the residual product trapping apparatus 100.

Further, the residual product trapping apparatus 100 is also connected to a refrigerant supply pipe 40 and a refrigerant discharge pipe 50 which are linked to an external refrigerant tank (not shown) in order to provide and collect a refrigerant to be used to cool the residual product of reaction. Accordingly, the refrigerant circulates via the refrigerant tank and the residual product trapping apparatus 100, and thus a fresh refrigerant is always supplied to the residual product trapping apparatus 100. The refrigerant may be a cooling water or a Freon gas.

The residual product trapping apparatus 100 having the aforementioned structure is constructed such that the residual product of reaction to be sucked into the vacuum pump 30 is further actively blocked, and an effective area on which the residual product of reaction is deposited and laminated in practice can be ensured as much as possible, thereby maximizing a trapping effectiveness.

Further, the residual product trapping apparatus 100 is constructed such that the trapped residual product of reaction can be easily removed without complication.

Now, the structure of the residual product trapping apparatus 100 according to an embodiment of the present invention will be described in detail.

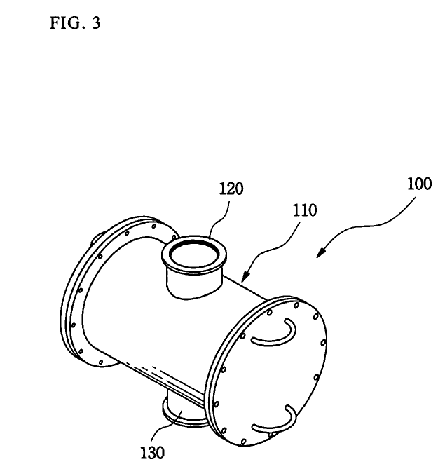

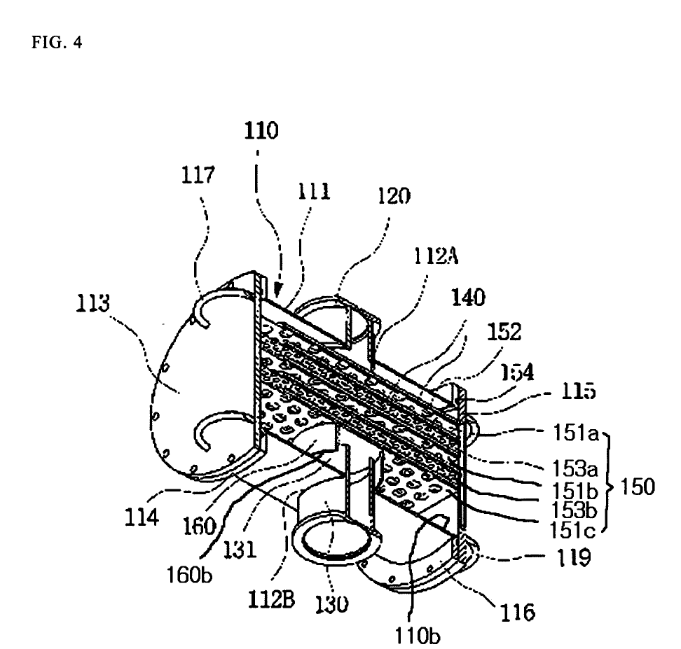

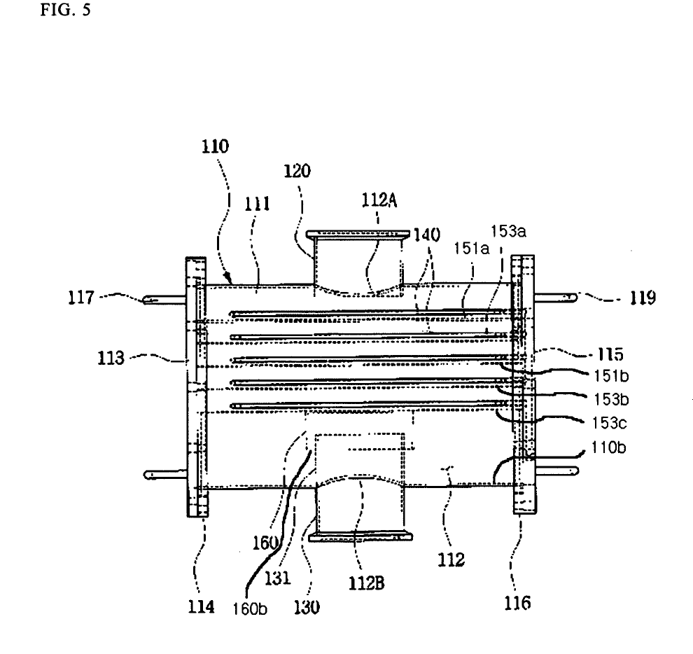

FIG. 3 is a perspective view of a residual product trapping apparatus according to an embodiment of the present invention. FIG. 4 is a partial exploded perspective view of the residual product trapping apparatus of FIG. 3. FIG. 5 is a front projection view of the residual product trapping apparatus of FIG. 3.

Referring to FIGS. 3 to 5, the residual product trapping apparatus 100 includes a housing 110 which has a containing space for trapping the residual product of reaction, a first connection pipe 120 and a second connection pipe 130 by which the housing 110 is respectively connected to the process chamber 10 (hereinafter see FIG. 2) and the vacuum pump 30 (hereinafter see FIG. 2), a cooling element 140 which rapidly cools the residual product of reaction to flow into the housing 110, a plurality of trap plates 150 on which the residual product of reaction is deposited and laminated, and a shielding cap 160.

The second connection pipe 130 of the residual product trapping apparatus 100 is formed with a protrusion 131 inwardly protruding from a base 110b of the housing 110. The shielding cap 160 is separated from the protrusion 131 to surround a vicinity of an entrance of the protrusion 131. Therefore, the residual product trapping apparatus 100 is formed such that the residual product of reaction in the form of powder or powder mass, which is included in the residual product of reaction flowing into the housing 110 and cannot be deposited or laminated on the trap plates 150, is blocked by a blocking operation of the second connection pipe 130 and the shielding cap 160 from sucking into the vacuum pump 30 through the second connection pipe 130 so as to be accumulated on the base 110b of the housing 110.

Furthermore, in the residual product trapping apparatus 100, an inner containing space of the housing 110 has a wider space in the horizontal direction than the vertical direction. Thus, the containing space of the housing 110 having the same volume can be installed with the trap plates 150 having a wider area, thereby increasing a trapping effectiveness of the residual product. Accordingly, the residual product trapping apparatus 100 minimizes the amount of residual product of reaction discharged not being trapped, and maximizes a trapping capacity of the residual product of reaction in the housing 110 having the same volume. Hereinafter, elements of the residual product trapping apparatus 100 will be further described in detail.

The housing 110 has a cylindrical shape in general. Its containing space is formed to have a horizontal length larger than a vertical length. That is, the housing 110 has a laterally laid cylindrical shape. If the housing 110 has a larger inner containing space in the horizontal direction than the vertical direction, the trap plates 150 can have a larger area in the containing space having the same volume. The exterior of the housing 110 is restricted due to a limited disposition space. The trap plates 150 are horizontally disposed with a limited number of layers. Accordingly, since an effective trapping area on which the residual product of reaction can be deposited and laminated in the same containing space can be further widely ensured when the containing space of the process chamber 10 is formed to be wider in the horizontal direction than the vertical direction, there is an advantage in that a trapping capacity is generally increased. Meanwhile, although the housing 110 has a cylindrical shape with a circular vertical cross-section, the housing 110 may has a square pillar shape with a square vertical cross-section, or a polygon pillar shape with a polygon vertical cross-section.

The housing 110 is composed of a main body 111 and a pair of covers 113 and 115. The main body 111 has a cylindrical shape of which left and right sides are open. The upper and lower sides thereof are provided with connection holes 112A and 112B to be connected to the first connection pipe 120 and the second connection pipe 130. The covers 113 and 115 include a first cover 113 and a second cover 115, and are respectively joined to the left and right sides of the main body 111 so as to block the opening sides, thereby forming a sealed containing space. Preferably, the covers 113 and 115 have a plate shape corresponding to the shape of the trap plates 150. For example, the covers 113 and 115 have a variety of plate shapes such as circular plate and a square plate shape. Further, the covers 113 and 115 are joined with the main body 111 by means of a joining element such as a bolt, so that the covers 113 and 115 can be detached therefrom after they are assembled and joined with the main body 111. In order for the covers 113 and 115 to be joined with the main body 111, rims of the left and right ends of the main body 111 are provided with round flanges 114 and 116. The flanges 114 and 116 are joined with the covers 113 and 115 by the use of the bolt, thereby forming flange coupling. Preferably, the outer surfaces of the covers 113 and 115 are provided with handles 117 and 119 for a user's convenience, so that a user can use them when assembling, disassembling, or transferring the housing 110. If the housing 110 is constructed by combining the main body 111 and the covers 113 and 115 which can be joined with and separated from each other, maintenance can be easily carried out, and the residual product of reaction deposited and laminated therein can be easily removed. However, the covers 113 and 115 may be able to be separated from any one of the left and right ends of the main body 111, and be integrated with the other end of the main body 111. For example, the main body 111 may have a cylindrical shaped container having an opening side, and the first cover 113 or the second cover 115 may be formed only at the opening side.

The first connection pipe 120 is installed at the connection hole 112A formed at the upper side of the main body 111 of the housing 110, and servers to connect the process chamber 10 and the housing 110.

The second connection pipe 130 is installed at the connection hole 112B formed at the lower side of the main body 111 of the housing 110 and servers to connect the process chamber 10 and vacuum pump 30. The protrusion 131 of the second connection pipe 130 is formed by inwardly extending the second connection pipe 130 from the base 110b of the housing 110. In this case, the upper surface of the protrusion 131 extends to be spaced apart by a predetermined distance from trap plates 151c installed at the lower side. When the second connection pipe 130 is formed to protrude into the housing 110 to some extent, the residual product of reaction, which is to be discharged through the second connection pipe 130 while transferring along the inner surface of the housing 110, can be effectively blocked. In this case, the residual product of reaction blocked by the protrusion 131 of the second connection pipe 130 is laminated on the base 110b of the housing 110, around the vicinity of the protrusion 131 of the second connection pipe 130.

Furthermore, in order to complement the second connection pipe 130, the residual product trapping apparatus 100 includes the shielding cap 160 to block the inflow of the residual product of reaction which falls down in the form of powder or powder mass. The shielding cap 160 has a shape of a container of which a lower side is open and which is spaced apart by a predetermined distance from the entrance of the protrusion 131 of the second connection pipe 130 to surround the vicinity of the entrance. The shielding cap 160 has a gap between a lower surface 160b and the base 110b of the housing 110 so that air can flow therethrough. The upper surface of the shielding cap 160 is bonded and fixed to a trap plate 150c disposed at the lowermost layer of the trap plates 150. The shielding cap 160 blocks the residual product of reaction, which cannot be laminated on the trap plates 150 and falls down after flowing into the house 110, so as not to flow into the entrance of the protrusion 131 of the second connection pipe 130. Accordingly, the protrusion 131 of the second connection pipe 130 and the shielding cap 160 can block the residual product of reaction to be sucked into the vacuum pump 30 through the second connection pipe 130 as much as possible, thereby minimizing the amount of the residual product of reaction sucked into the vacuum pump 30.

The cooling element 140 is formed with a cooling line in the shape of a coil that is repeatedly bent and adjacent to the trap plates 150 inside the housing 110. Further, the cooling line of the cooling element 140 serves to decrease the internal temperatures of the trap plates 150 and the housing 110 by circulating a fresh refrigerant supplied from an external refrigerant tank (not shown). Accordingly, the residual product of reaction flowing into the housing 110 comes in contact with the housing 110 and the trap plates 150 which are cooled by the cooling element 140, and thus is rapidly cooled to be solidified into powder. As a result, the residual product of reaction is deposited on the inner surface of the housing 110 and the surfaces of the trap plates 150. In general, during semiconductor processing, the process chamber 10 maintains its internal temperature ranging from 400° C. to 500° C. In comparison, the inner surface temperature of the housing 110 and the surface temperature of the cooling element 140 are maintained to be relatively low by the cooling element 140. The housing 110 and the trap plates 150 maintain a temperature of 200° C. or less, preferably 100° C. or less. More preferably, the temperature may be 50° C. or less. Accordingly, when the residual product of reaction generated inside the process chamber 10, in particular, a non-reactive gas, flows into the housing 110 through the first connection pipe 120 and comes in contact with the surfaces of the trap plates 150, it is instantly converted into a solid state from a vapor state, and is deposed to form a film. Meanwhile, the rest of the residual product of reaction which is not deposited in the process of forming the film is rapidly cooled at a low temperature inside the housing 110. As a result, solidification proceeds, and thus the residual product falls down in a powder state, and is accumulated on the trap plates 150.

Preferably, in order to enhance a cooling effectiveness by the use of the refrigerant as described above, each of the trap plates 150 and the cooling line of the cooling element 140 are formed of a metal material which has an excellent thermal conductivity and is anti-corrosive against a semiconductor processing gas. The trap plates 150 and the cooling element 140 may be formed of copper, aluminum, or stainless metal. However, the present invention is not limited to the material, and may be formed of a variety of thermal conductive and anti-corrosive materials.

In the trap plates 150, a plurality of trap plates 151a, 151b, 151c, 153a, and 153b are arranged in a layer form inside the housing 110, with being spaced apart by a predetermined distance from top to down. Further, in the trap plates 150, the trap plates 151a, 151b, and 151c having a relatively large punching hole, and the trap plates 153a and 153b having a small punching hole 154 are alternately arranged in each layer. If the trap plates 151a, 151b, 151c, 153a, and 153b having relatively differently sized punching holes 152 and 154 are alternately arranged, the trap plates 150 can have an advantage in that the residual product of reaction can smoothly flow without an excessive load and can be dispersed to be deposited and laminated on the upper surface of each of the trap plates 151a, 151b, 151c, 153a, and 153b. In this case, it is preferable that the trap plate 151a having the large punching hole 152 is arranged in the uppermost layer of the trap plates 150. This is to avoid an initial flow of the residual product of reaction against interruption immediately after the residual product of reaction flows into the housing 110 through the first connection pipe 120. Preferably, one ends of the trap plates 150 are fixed to be joined to and supported by any one of the covers 113 and 115 of the pair of covers 113 and 115 which can be connected to and separated from the main body 111. This is because each of the trap plates 150 can be taken out along with the housing 110 when the user detaches the covers 113 and 115 therefrom after the residual product of reaction is trapped by the residual product trapping apparatus 100. Accordingly, the residual product of reaction deposited and laminated on the trap plates 150 can be rapidly and easily removed.

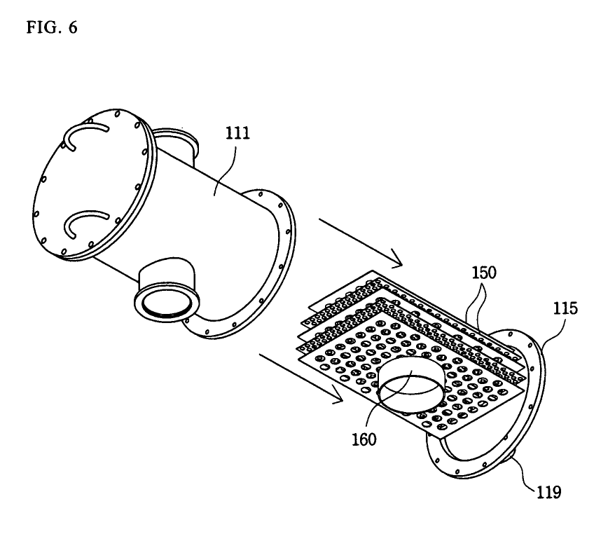

Further, the residual product trapping apparatus 100 can be conveniently assembled or maintained. FIG. 6 shows the trap plates 150 which are taken out along with the covers 113 and 115 separated from the main body 111 according to an embodiment of the present invention.

Now, the operation of the residual product trapping apparatus having the aforementioned structure will be described with reference to the accompanying drawings.

First, when the residual product trapping apparatus 100 is driven to operate, the cooling element 140 connected to an external refrigerant tank (not shown) supplies into the housing 100 a fresh low temperature refrigerant to be circulated therein. In the housing 110, when the fresh refrigerant is supplied from the cooling element 140, the surface temperature of the trap plates 150 and the inner surface temperature of the housing 110 are rapidly decreased.

In an operating state of the residual product trapping apparatus 100, after a thin film deposition or etching process is completed, the residual product of reaction including a large amount of non-reactive gases generated during the thin film deposition or etching process is generated in the process chamber 10 connected to the residual product trapping apparatus 100. Further, as the vacuum pump 30 operates, the residual product of reaction discharged from the process chamber 10 flows into the housing 110 through the first connection pipe 120.

While being dispersed, the residual product of reaction flowing into the housing 110 comes in contact with the inner surface of the housing 110 and the surfaces of the trap plates 150 which have already been cooled to a low temperature. Thus, the residual product of reaction is instantly cooled when in contact with the inner surface of the housing 110 and the surface of the trap plate 150, and is rapidly solidified in a vapor state to be deposited. In this case, the residual product of reaction flowing into the housing 110 is deposited while being initially in contact with the surface of the trap plates 150 disposed at the uppermost layer. On the other hand, the rest of residual product which is not deposited flows through the punching holes 152 and 153 formed on the trap plates 150 and is deposited while being gradually in contact with the rest of the trap plates 150 disposed at the lower layers. In this process, the residual product of reaction alternately passes through the two types of the trap plates 151 and 153 having the relatively large and small punching holes 152 and 154. Accordingly, the residual product of reaction smoothly flows without abruptly receiving an excessive load, and is deposited uniformly in quantity on the surface of the trap plates 150 disposed in each layer.

In this case, the rest of the residual product of reaction which is in a vapor state and is not deposited in the film forming process is also solidified into powder due to a low temperature inside the housing 110, and some portions thereof are accumulated on the surface of the trap plate 151a disposed at the uppermost layer. Further, the rest portions thereof are accumulated on the surfaces of the trap plates 153a, 151b, and 153b disposed at the lower layers, while falling down through the punching holes 152 and 154 of the trap plates 150. In this manner, the residual product of reaction repeatedly falls down on the trap plates 153a, 151b, and 153b disposed at the lower layers. As a result, the residual product of reaction can be generally uniformly accumulated thereon from the trap plate 151a disposed at the uppermost layer to the trap plate 151c disposed at the lowermost layer.

On the other hand, in the case of the rest of the residual product of reaction which is not deposited or laminated on the trap plates 150 and further falls down, the residual product of reaction is accumulated on the base 110b of the housing 110 instead of being discharged through the second connection pipe 130. This is because the protrusion 131 inwardly protrudes from the base 110b of the housing 110, and the shielding cap 160 surrounds the vicinity of the entrance of the protrusion 131 to block the falling residual product of reaction. That is, the shielding cap 160 blocks the falling residual product of reaction from directly flowing into the second connection pipe 130. Further, after the residual product of reaction reaches the base 110b of the housing 110, suction of the residual product of reaction through the second connection pipe 130 by a vacuum pressure of the vacuum pump is blocked by the outer surface of the protrusion 131 of the second connection pipe 130, and thus the residual product of reaction is accumulated around thereof.

Accordingly, a portion of the residual product of reaction flowing into the housing 110 is deposited and rapidly formed into a film on the inner surface of the housing 110 and the surface of the trap plates 150, and another portion of the residual product of reaction is accumulated on the trap plates 150 after being solidified at a cooled temperature inside the housing 110. Further, the rest of the cooled-off temperature which falls down instead of being accumulated on the trap plates 150 is blocked without having to be sucked into the second connection pipe 130, and is accumulated near the protrusion 131 of the second connection pipe 130 at the base 110b of the housing 110.

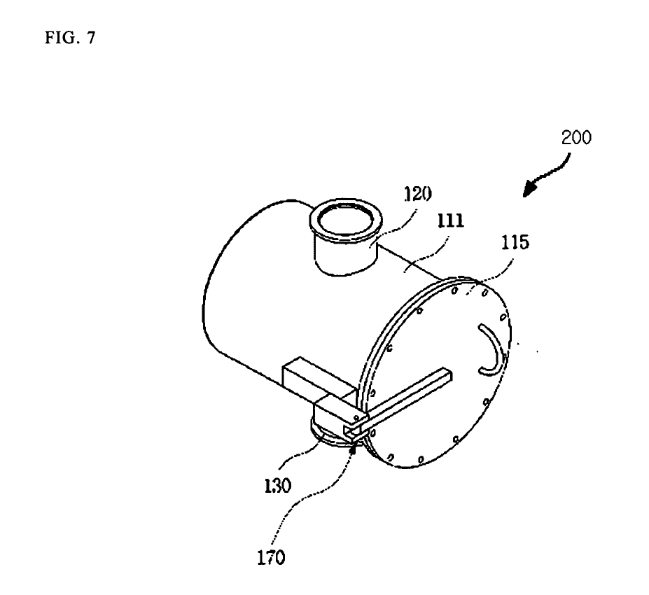

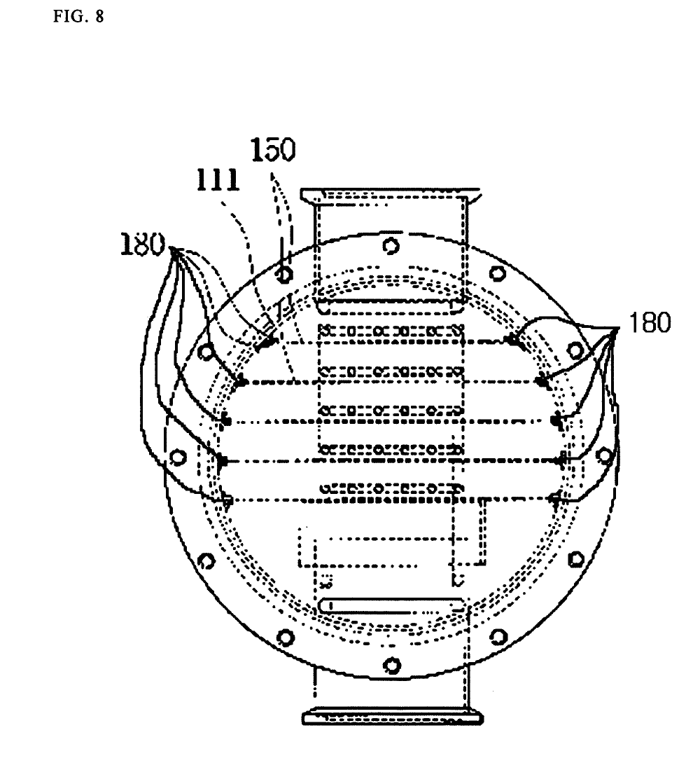

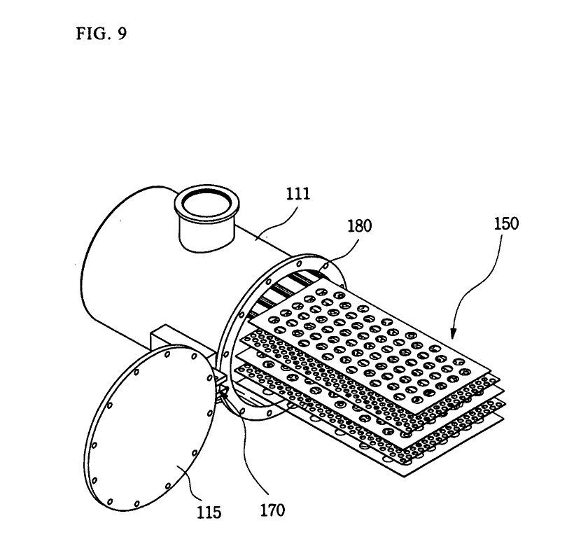

FIG. 7 is a perspective view of a residual product trapping apparatus according to another embodiment of the present invention. FIG. 8 is a lateral projection view of the residual product trapping apparatus of FIG. 7. FIG. 9 is an exploded perspective view of a main body and a cover of the residual product trapping apparatus of FIG. 7.

Referring to FIGS. 7 to 9, a residual product trapping apparatus 200 according to another embodiment of the present invention further includes a hinge member 170 which is disposed between the main body 111 and the cover 115 to rotatably connect them in an opening and closing manner. The hinge member 170 is joined with at least one cover 115 of the covers joined at the left and right sides of the main body 111.

The residual product trapping apparatus 200 further includes a guide rail 180 which is formed on the inner circumferential surface of the main body 111 in a longitudinal direction and supports both ends of each of the trap plates 150 in a sliding manner. When the trap plates 150 are inserted into the housing 110, the guide rail 180 allows the trap plates 150 to be horizontally inserted to be stably supported. Since a pair of guide rails 180 support the trap plates 150 at both sides, the number of pairs thereof corresponds to the number of trap plates 150. In the residual product trapping apparatus 200, once the guide rail 180 is installed, the trap plates 150 can be individually taken out from the main body 111. Accordingly, since the residual product trapping apparatus 200 can remove the trapped residual product by individually disassembling the trap plates 150, the removing operation or maintenance can be further conveniently carried out. However, in this case, unlike the residual product trapping apparatus 100 of FIGS. 3 to 5, the trap plates 150 are not bonded and fixed to the cover 115.

While the present invention has been particularly shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

### INDUSTRIAL APPLICABILITY

Accordingly, the residual product trapping apparatus of the present invention can improve a trapping effectiveness by actively blocking the residual product of reaction from sucking into the vacuum pump due to the shielding cap and the protrusion of the second connection pipe.

In addition, since the wide trap plates can be installed, and the base of the housing can be actively used for trapping the residual product of reaction, a trapping capacity can be significantly increased.

In addition, since the two types of trap plates having relatively differently sized punching holes are alternately disposed, the residual product of reaction is generally uniformly deposited or laminated on the trap plates, thereby trapping the residual product of reaction in greater quantity.

In addition, the trapping capacity can be increased, and the deposition and lamination can be uniformly achieved, and thus the residual product of reaction can be trapped for long period of time. As a result, in comparison with the conventional case in which the residual product of reaction has to be removed frequently, an equipment operation rate can be improved.

In addition, when the trapped residual product of reaction is removed, the trap plates can be easily taken out of the housing by separating the cover or opening/closing the cover like a door. Therefore, not only a removal task for the residual product of reaction but also a maintenance task thereof can be easily carried out.

What is claimed is:

1. A residual product trapping apparatus which is disposed between a process chamber and a vacuum pump and traps a residual product of reaction generated during a thin film deposition or etching process, the apparatus comprising:
a hollow housing having an inner containing space;
a first connection pipe which is formed at the upper side of the housing to connect the process chamber and the housing, and allows the residual product of reaction discharged from the process chamber to flow into the housing;
a second connection pipe which connects the vacuum pump and the housing, and includes a protrusion which inwardly extends and protrudes from a base of the housing;
trap plates which are disposed inside the housing in the form of multiple layers and on which the residual product of reaction is laminated; and
a cooling element which is disposed inside the housing and cools the residual product of reaction flowing into the housing through the first connection pipe.

2. The apparatus according to claim 1, further comprising a shielding cap which is disposed inside the housing and is separated from the protrusion to surround the vicinity of the entrance of the protrusion of the second connection pipe.

3. The apparatus according to claim 2, wherein the shielding cap has a shape of a container of which a lower side facing the second connection pipe is open, an upper surface is fixed to a trap plate which is included in the trap plates and is disposed at the lowermost layer, and a lower surface is disposed to form a gap between the base of the housing and the lower surface.

4. The apparatus according to any claim 1, wherein the containing space of the housing has a wider space in the horizontal direction than the vertical direction.

5. The apparatus according to claim 4, wherein the housing has a cylindrical shape of which left and right sides are open, and includes a main body respectively connected to the first connection pipe and the second connection pipe, and a pair or covers which are respectively connected to the left and right sides of the main body and blocks the opening sides of the main body.

6. The apparatus according to claim 5, wherein at least one of the covers is rotatably hinge-connected to the main body in an opening and closing manner against the main body.

7. The apparatus according to claim 5, wherein the housing further includes a guide rail which is disposed on the inner circumferential surface of the main body and supports each of the trap plates in a sliding manner.

8. The apparatus according to claim 5, wherein one ends of the trap plates are bonded to and supported by any one of the covers, and the cover to which each of the trap plates is bonded can be connected to or separated from the main body.

9. The apparatus according to claim 1, wherein the cooling element includes a coil type cooling line having a shape of coil that is repeatedly bent and adjacent to the trap plates and reduces an internal temperature of each of the trap plates and the housing while circulating a refrigerant.

10. The apparatus according to claim 1, wherein the trap plates include a plurality of punching holes.

11. The apparatus according to claim 10, wherein each of the trap plates includes a trap plate having a relatively large punching hole and a trap plate having a relatively small punching hole are alternately disposed in each layer.

12. A residual product trapping apparatus which is disposed between a process chamber and a vacuum pump and traps a residual product of reaction generated during a thin film deposition or etching process, the apparatus comprising:
a hollow housing having an inner containing space;
a first connection pipe which connects the process chamber and the housing;
a second connection pipe which connects the vacuum pump and the housing, and includes a protrusion which inwardly extends and protrudes from a base of the housing;
a cooling element which is disposed inside the housing and cools the residual product of reaction flowing into the housing through the first connection pipe; and
a shielding cap which is disposed inside the housing and is separated from the protrusion to surround the vicinity of the entrance of the protrusion of the second connection pipe.

13. A residual product trapping apparatus which is disposed between a process chamber and a vacuum pump and traps a residual product of reaction generated during a thin film deposition or etching process, the apparatus comprising:
a housing which includes a main body, of which left and right sides are open and which has a wider containing space in the horizontal direction than the vertical direction, and a pair of circular plate shaped covers which are respectively joined to the left and right sides of the main body and blocks the opening sides of the main body, wherein any one of the covers is hinge-joined with the main body so as to rotate against the main body in an opening and closing manner;
a first connection pipe which connects the process chamber and the housing;
a second connection pipe which connects a vacuum pump disposed to make the process chamber vacuous and the housing and in which a protrusion inwardly extends and protrudes from the inner side of the housing to block the residual protrude of reaction flowing out along the inner surface of the housing;
a plurality of trap plates which are disposed inside the housing in the form of multiple layers wherein two types of trap plates having relatively large and small punching holes are alternately disposed in each layer, and in which the residual product of reaction is laminated;
a shielding cap which is disposed inside the housing and is separated from the protrusion to surround the vicinity of the entrance of the protrusion of the second connection pipe, has a shape of a container of which a lower side facing the second connection pipe is open and of which an upper surface is fixed to a trap plate included in the trap plates and disposed at the lowermost layer, and blocks the falling residual product of reaction flowing out through the second connection pipe; and
a cooling element which includes a coil type cooling line having a shape of coil that is repeatedly bent and adjacent to each of the trap plates and reduces an internal temperature of each of the trap plates and the housing while circulating a refrigerant, and cools the residual product of reaction flowing into the housing through the first connection pipe.

14. The apparatus according to any claim 2, wherein the containing space of the housing has a wider space in the horizontal direction than the vertical direction.

15. The apparatus according to claim 14, wherein the housing has a cylindrical shape of which left and right sides are open, and includes a main body respectively connected to the first connection pipe and the second connection pipe, and a pair or covers which are respectively connected to the left and right sides of the main body and blocks the opening sides of the main body.

16. The apparatus according to any claim 3, wherein the containing space of the housing has a wider space in the horizontal direction than the vertical direction.

17. The apparatus according to claim 16, wherein the housing has a cylindrical shape of which left and right sides are open, and includes a main body respectively connected to the first connection pipe and the second connection pipe, and a pair or covers which are respectively connected to the left and right sides of the main body and blocks the opening sides of the main body.

18. The apparatus according to claim 17, wherein at least one of the covers is rotatably hinge-connected to the main body in an opening and closing manner against the main body.

19. The apparatus according to claim 17, wherein the housing further includes a guide rail which is disposed on the inner circumferential surface of the main body and supports each of the trap plates in a sliding manner.

20. The apparatus according to claim 17, wherein one ends of the trap plates are bonded to and supported by any one of the covers, and the cover to which each of the trap plates is bonded can be connected to or separated from the main body.
